(19) United States
(12) Patent Application Publication
(10) Pub. No.: US 2016/0134712 A1
(43) Pub. Date: May 12, 2016

(54) METHOD, SYSTEM, AND GRAPHICAL USER INTERFACE FOR SHARING MEDIA ITEMS FROM THIRD PARTY MEDIA SOURCES

(71) Applicant: CRT & Associates, Inc., Dollar Bay, MI (US)

(72) Inventors: Gerald E. Milatz, Traverse City, MI (US); Karen A. Milatz, Traverse City, MI (US)

(21) Appl. No.: 14/934,584

(22) Filed: Nov. 6, 2015

Related U.S. Application Data
(60) Provisional application No. 62/076,240, filed on Nov. 6, 2014.

(51) Int. Cl. H04L 29/08; H04L 29/06

(52) U.S. Cl. CPC H04L 67/20; H04L 67/16; H04L 67/42

(57) ABSTRACT

A method for sharing media items from third party media sources and a graphical user interface for sharing media items. Media items such as images, videos, etc., may be available from various third party media sources at events such as sports games and concerts. Allowing users to share media items from these third party media sources can provide users with a more robust experience, as the need for users to obtain their own images, videos, etc, of the event may be obviated.

This is a non-provisional patent application which claims the benefit of U.S. provisional patent application Ser. No. 62/076,240, filed on Nov. 6, 2014, the disclosure of which is incorporated herein by reference in its entirety.

### TECHNICAL FIELD

The present invention generally relates to communication networks, and, more particularly, to systems, methods, and graphical user interfaces that use communication networks to share media items through social media platforms.

### BACKGROUND

Social media platforms have become a prolific means of communication, particularly in conjunction with real-time events such as network broadcasts, sporting events, concerts and other entertainment events, etc. Oftentimes, with events such as professional sports games and concerts where a large number of social media users are present in one venue, it may not be possible for the user to get close enough to the action to obtain a photo or short video of the event for example. Many users may make an extraordinary effort to obtain a photo that is of sufficient quality, thereby creating dangerous and unsafe conditions in crowded venues, arenas, and stadiums. Accordingly, there is a need to provide publicly accessible, high quality imagery from media sources that can be easily shared on social media platforms.

### SUMMARY

According to one embodiment, there is provided a method for sharing media items from third party media sources. The method includes the steps of obtaining one or more media items from one or more third party media sources; storing the one or more media items on a storage device; providing a communications network; enabling access to the communications network by a user employing a computing device, the computing device having memory and a graphical user interface including an electronic display; receiving a request to view at least one of the stored media items from the user via the graphical user interface display of the user's computing device, which allows the user to select among the media items; and allowing the user to share a post including the one or more media items from the storage device with a social media platform without storing the one or more media items on the memory of the user's computing device.

According to one embodiment, there is provided a graphical user interface produced by an application program operating on a computing device having an electronic display. The graphical user interface comprises a first application program window presented on the electronic display. The first application program window is generated by the application program operating on the computing device. The first application program window displays a plurality of selectable media items received by the application program from a remote storage device over a communications network. Upon user selection, at least one media item can be added to a post that will be shared with at least one social media platform. The graphical user interface further comprises a second application program window presented on the electronic display. The second application program window is generated by the application program operating on the computing device. The second application program window displays the post containing the at least one selected media item and the post is received by the at least one social media platform from the remote storage device

### BRIEF DESCRIPTION OF THE DRAWINGS

FIG. 1 is a block diagram of an example embodiment of a system for sharing media items from third party media sources;

FIGS. 2-5 are screen shots of example application program windows on a graphical user interface display;

FIG. 6 shows an example of a social media post containing a media item;

FIG. 7 is a screen shot of an example application program window on a graphical user interface display showing a list of devices or device locations where media items may originate from and

FIG. 8 is a flowchart illustrating an example embodiment of the method for sharing media items and may be used with a system such as the one shown in FIG. 1,

### DETAILED DESCRIPTION

In general, the system and methods described herein can allow for efficient and reliable sharing of media items obtained from third party media sources. The system generally may include a user employing a computing device, third party media sources, one or more servers or other related storage devices, a communications network, and various social media platforms. The methods allow the user to share a post that includes a media item with a social media platform without storing the media item on the memory of the user's computing device.

The example embodiments will be described with reference to their use in an exemplary system for sharing media items Obtained from third party media sources. However, it should be appreciated that the methods, systems, and graphical user interfaces described herein are useful in many different applications and may be implemented in many other embodiments. In this regard, the system description below is merely illustrative of one example, and the methods may be used in any suitable environment with any suitable system architectures, hardware, software, firmware, content, and/or the like. It should be understood that the disclosed method may be used with any number of different systems and is not specifically limited to the operating environment shown here. Thus, the following description simply provides a brief overview of one such exemplary system; however, other systems not shown here could employ the disclosed methods as well.

System

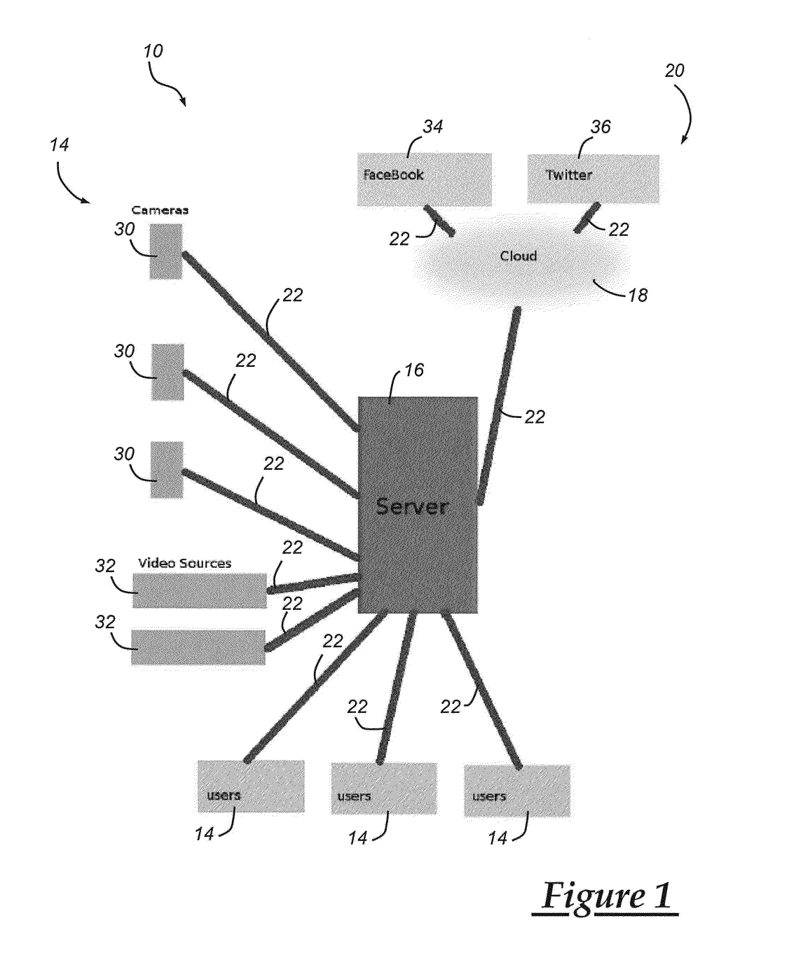

FIG. 1 illustrates an exemplary embodiment of an operating environment in the form of a system 10 that may be used to implement computer-assisted methods of sharing media items from third party media sources using a communications network. The system 10 may include the following subsystems, system elements, or system components, to receive, process, and/or transmit data: one or more users employing a computing device 12, third party media sources 14, storage devices 16, 18, at least one social media platform 20, and a communication network 22 to provide communication among and between one or more of the aforementioned other system components. The communication network 22 may include one or more wireless networks, one or more wired networks, and/or the Internet. Additional system components may include, but are not limited to, various system administrators, web-hosts, third party enablers such as PayPal if a paid-for service is desired for example, external service providers, business facilitators, and/or any other entity that may enable one or more features of the presently disclosed methods. Moreover, as will be apparent from one having skill in the art, other system architecture configurations may be used, including any combination of data processing centers, offices, stations, backend facilities, servers, or the like, and may or may not be located in, near, or as a part of any other system components.

System Users

The system 10 includes users employing a computing device 12. In a preferred embodiment, the users are attendees at events such as concerts, lectures and other presentations, sporting events, or any high density data usage environment, in another example, the users may be located in areas outside of such events but still have access to the communications network 20. The system may be used in numerous event venues, including but not limited to a vehicle of any kind, a store, residence, restaurant, arena, stadium, race track, field, court, course, auditorium, theater, performing arts center, hall, convention center, and/or any other suitable gathering place, for example, to travel, or observe or participate in an event or the like. As used herein, the term “users” may include travelers, customers, trade show exhibitors, spectators, fans, observers, attendees, and/or any other suitable people. In some embodiments, the users are in attendance at a venue, for example, to observe or participate in an event or the like. In other embodiments, the users may be observing a broadcast via television, Internet, radio, and/or any other suitable medium. In another embodiment, a user of a computing device 12 includes an automated or semi-automated program designed to post certain media items to one or more social networking platforms based on pre-determined criteria such as time intervals or situational cues, for example.

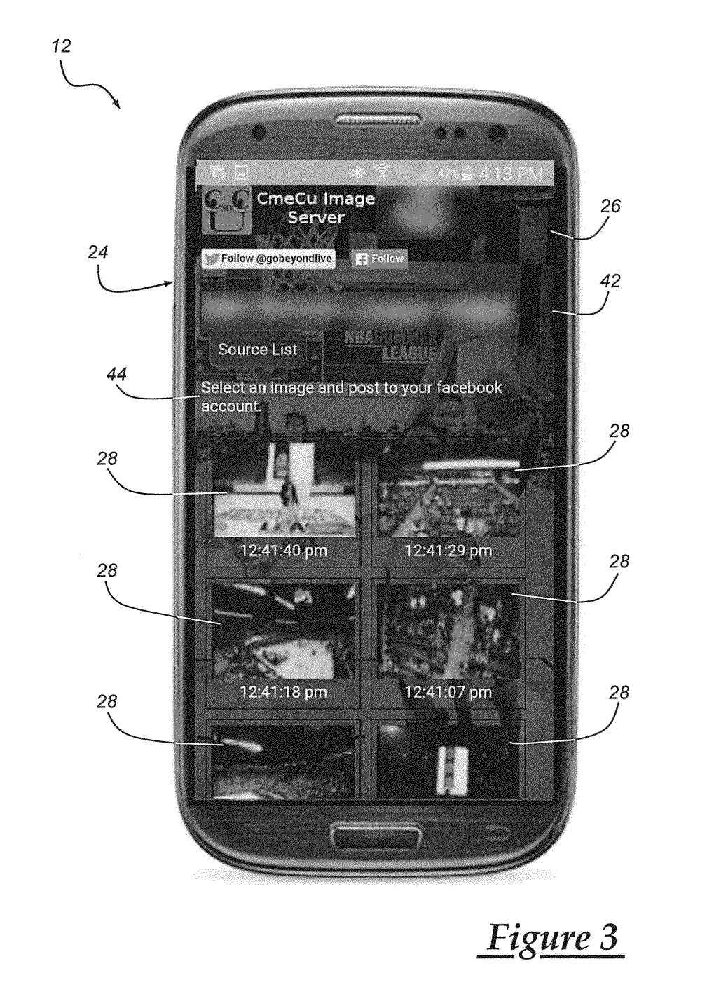

The users may employ one or more computing devices 12. FIGS, 2 and 3 show an example of a computing device 12. The computing device 12 has memory (not shown) and a graphical user interface 24 that includes an electronic display 26. In general, the user can request to view one or more stored media items 28 as shown in FIG. 3, and share a post including the one or more media items 28 without storing the media items on the memory of the user's computing device 12. The user computing devices 12 may be fixed or mobile products and may include personal mobile smart phones, other mobile telephones, tablet computers, PDAs, gaming devices, laptop or notebook computers, personal computers, computers located at seats or kiosks of the venue, and/or any other suitable products. The user computing devices 12 may be configured to store and process information and computer-readable media that may include data and/or computer application programs. The user computing devices 12 may run any suitable software platform, sonic non-limiting examples including BlackBerry, Android, Apple iOS, and Windows Phone, among others. User computing devices 12 may include any suitable brand of communication or entertainment device. A user may also employ more than one computing device. Because the number of devices and connections per user is increasing, there is an increased demand for data services over communications networks, particularly wireless networks. With the increase in user densities, there is a corresponding need to offload network access, particularly in high density environments such as entertainment and sporting events.

Third Party Media Sources

With reference to FIG. 1, third party media sources 14 may include cameras 30 and video sources 32. As used herein, “third party media sources” include any device or medium for obtaining one or more media items, including images, videos, audio excerpts, etc. The phrase “third party” in particular is meant to imply that the media sources such as cameras, recorders, etc. are distinct from the cameras, recorders, etc. that are incorporated with the users computer device 12. In a preferred embodiment, the third party media sources 14 are recording an entertainment or sporting event that the users employing computer devices 12 are attending. Third party media sources typically record or otherwise stream one or more media items independent of media items stored in the memory of the user computing devices 12. Accordingly, third party media sources allow users to review, browse, preview, and/or share media items that may not have been otherwise available to the users that may be at the event.

In accordance with one embodiment, cameras 30 and video sources 32 provide the system 10 with still images, video, and/or other media items that can be used by the present method to share with various social media platforms 20. Cameras 30 may be designed to move locally such as rotating, tilting, zooming in, zooming out, or panning; move in accordance with a wire, track, or other guidance system; or they could simply be stationary, fixed, or otherwise immobile. Examples of potential camera types include pan-tilt-zoom (PTZ) cameras, closed circuit television (CCTV) cameras, interact protocol (IP) cameras, still imaging cameras, and illuminated or non-illuminated cameras, just to name a few. Cameras 30 may include aerial-mounted cameras such as satellites or unmanned aerial vehicles (UAVs), airplanes, blimps, helicopters, etc. that may be equipped with aerial-mounted still or video cameras. Video sources 32 may include, but are not limited to, set top boxes, network broadcasts, internet webcasts, or any other source of recorded or streaming media. The cameras may also be programmed to record images at a predefined interval or upon a triggering event.

It is possible for the third party media sources 14 to include a storage device internally or to connect to a storage device such as the remote storage device 16. The connection may be a wired connection (e.g., a fiber optic, cable, or other wired connection), a wireless connection that allows uploading and/or downloading of media items, or an indirect connection via other monitoring centers or network broadcasting centers, to cite a few possibilities. The particular type of third party media source, the particular mounting arrangement of the third party media source, the particular location of the third party media source, and the particular connection between the third party media source and the storage device, etc., is not imperative to the present method and system, as any suitable arrangement may be used. There is no specific limit on the number or combination of third party image sources that may be employed, including the cameras 30 and video sources 32 shown and described.

Third party media sources 14 may obtain input for the system 10 such as the media items 28 depicted in FIG. 3. The media items may be in various sizes, qualities, and formats, including but not limited to Jpeg, Mpeg, PNG, GIF, etc. An advertisement or other insignia may be overlaid on top of, or otherwise integrated with, the media items. The media items may include any number and/or combination of still images, videos, and audio excerpts. In one embodiment, a media item such as a video is segmented into a number of image stills and/or video clips. This processing may be done by the third party media source itself, or at a storage device such as storage device 16 through the use of various processing programs, for example. In a potential embodiment, the method may use high dynamic range imaging (HDRI or HDR), frequency band analysis, hyper spectral imaging, motion detection and/or recognition, or other techniques that improve the ability of the method to analyze, segment, capture, or otherwise process the output of the third party media sources 14 across a wide spectrum of frequencies, both within and outside of the visible light range.

Communication Network

The communication network 22 facilitates data transmission between the various system components including user computing devices 12, third party media sources 14, remote storage device 16, other potential storage devices such as intermediate storage device 18, and social media platforms 20. The communication network 22 may include any suitable local area network, wide area network, which may include the Internet or Ethernet, and/or the like. The communication network 22 may include any wireless network. HD wireless network, land network, point-to-point network, cellular communication network, distributed antenna system (DAS), or any combination thereof, that is adapted to transmit and receive signals to and from one or more of the other components 12 through 20 of the system 10. In one embodiment, the system components may communicate in accordance with hypertext transport protocol (HTTP), transport-control protocol and Internet protocol (TCP/IP), and/or any other suitable communication standard(s). Moreover, network browsers, web-hosts, or application programs may be used as interfaces loaded to the user computing devices 12 and/or one or more of the other system components for carrying out at least portions of the methods described herein.

A wireless network may include at least a portion of a wireless communications carrier, a mobile telephone system, a satellite broadcast system, and/or the like, that incorporates any type of telecommunications in which electromagnetic waves carry signals over part of or an entire communication path. A wireless network may also or instead include any suitable hardware, software, and/or firmware to communicate wirelessly according to one or more of IEEE 802.11 WiFi protocols, WiMAX, Bluetooth, and/or any other suitable wireless protocols. A wireless network may include a mobile ad hoc network (MANET), wireless ad hoc network, wireless mesh network, or the like, that may include two or more user computing devices 12, and/or the like. A wireless network may further include a cellular system that includes a plurality of cell towers, one or more mobile switching centers, for example, and may implement any suitable communications technology, including for example, analog technologies (e.g. AMPS3) and/or digital technologies (e.g. GSM/GPRS, CDMA, CDMA2000, OFDMA, 3G, 4G, 5G, etc.). Data may be sent either via a data connection, such as via packet data transmission over a data channel.

A wired network, if incorporated, may include a land network used to connect at least two of the various system elements 12 through 20. For example, the land network may include a public switched telephone network (PSTN) to provide hardwired telephony, packet-switched data communications, and/or Internet infrastructure. A land network may include an Internet protocol (IP) network, fiber optic network, and/or any combination thereof One or more segments of a land network could be implemented through the use of a standard wired network, a fiber or other optical network, a cable network, power lines, other wireless networks such as wireless local area networks (WLANs), or networks providing broadband wireless access (BWA), or any combination thereof.

Storage Devices

With reference to FIG. 1, one or more storage devices such as remote storage device 16 and intermediate storage device 18 may be used to facilitate data transmission between the various system components 12, 14, and 20. A storage device may include any number and/or combination of servers, cloud storage devices or programs, computers, databases, switches, routers, data storage capabilities and/or other electronic devices needed to carry out the present method, and it may be completely automated or staffed with live employees, to name a few possibilities. In one embodiment, the remote storage device 16 is a server that uploads or accepts download of media items from the third party media sources 14. Upon instruction from a user computing device 12, the one or media items can be added to a post and transmitted to an intermediate storage device 18. The post may include the one or more media items and user input material such as text. In a more particular embodiment, the intermediate storage device is a cloud, but it may be another remote server or notification server that allows the post to be retrieved by one or more social media platform(s) 20. Moreover, it could also be possible to transmit the post from the remote storage device 16 directly to the one or more social media platforms 20. In one sense, the one or more storage devices serve as staging areas to allow the creation and subsequent sharing of posts that include one or more media items. This can streamline data transmission because users can access and share event-related media items without using network bandwidth to store the media items on their personal computing devices. In another embodiment, the storage device may be incorporated as part of the third party image source 14. Skilled artisans will appreciate that multiple configurations and storage device types and configurations may be used. Moreover, the precise division of tasks or processing steps between the user computing devices 12, the third party media sources 14, and the one or more storage devices may be made according to any suitable processing scheme,

Social Media Platforms

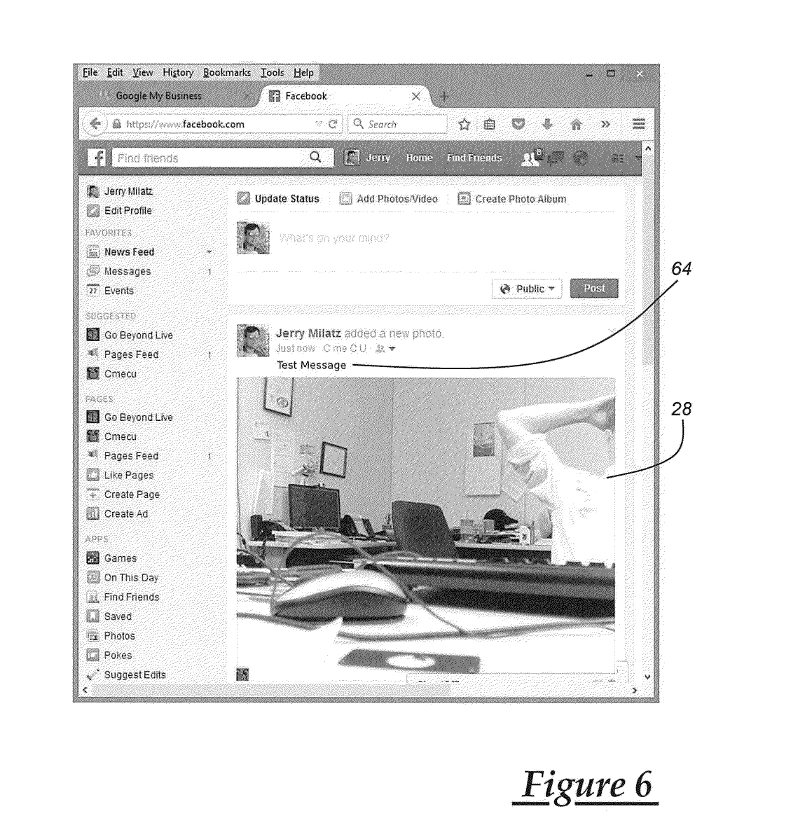

Social media platforms 20 enable the sharing of media items such as images, videos, audio excerpts, information, messages, and/or the like. In one embodiment social media platforms 20 include a Facebook account 34 and a Twitter account 36. Generally, although not necessarily, the media items are incorporated into a post that includes optional user input material, An example Facebook post is shown in FIG. 6 that includes the media item 28 and user input material 64 in the form of text. It should be understood that any content sharing site or platform may be used with the present system and method, including Instagram, Pinterest, Vine, LinkedIn, Snapchat, Flickr, and Google+, to cite a few possibilities.

Graphical User Interface

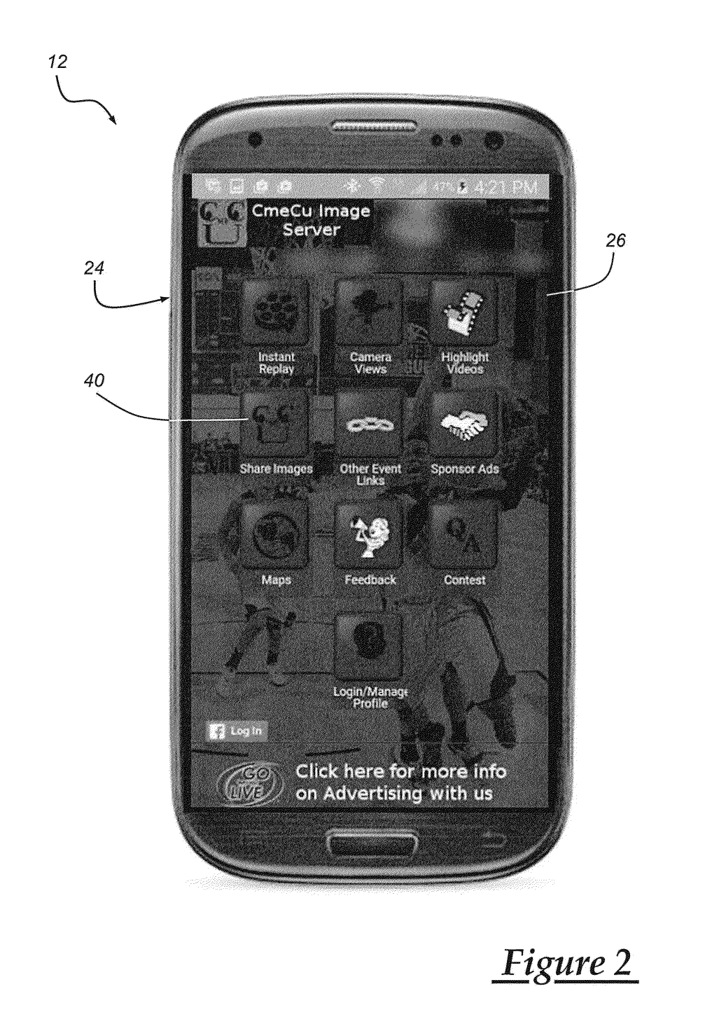

With reference to FIGS. 2 through 5, a graphical user interface 24 includes an electronic display 26 and is suitable for reviewing, browsing, previewing, and/or sharing media items 28. The graphical user interface can be presented to a user at the user's computing device 12. In one embodiment, the graphical user interface is presented to the user by an application program that runs on the user's computing device 12. The application program may be designed for a native iOS platform, a native Android platform, or with cross-platforms tools such as PhoneGap, Unity, Appcelerator Titanium, to name a few possibilities. It should be noted that the application program may be alternatively he an Internet or website driven program accessed by the user through a network browser. The graphical user interface may be implemented by software, hardware, or a combination of hardware and software. The graphical user interface can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion, As shown in FIG. 2, an application program may be incorporated within another application program and accessible from a menu icon, such as a share still images icon 40, for example. The graphical user interface 24 may include a number of application program windows presented on the electronic display that are generated by the application program. It should also be noted that the application program windows described below can be in the form of independent application program windows or may be designed as sub-windows of other windows, and other configurations and designs are certainly possible.

First Application Program Window

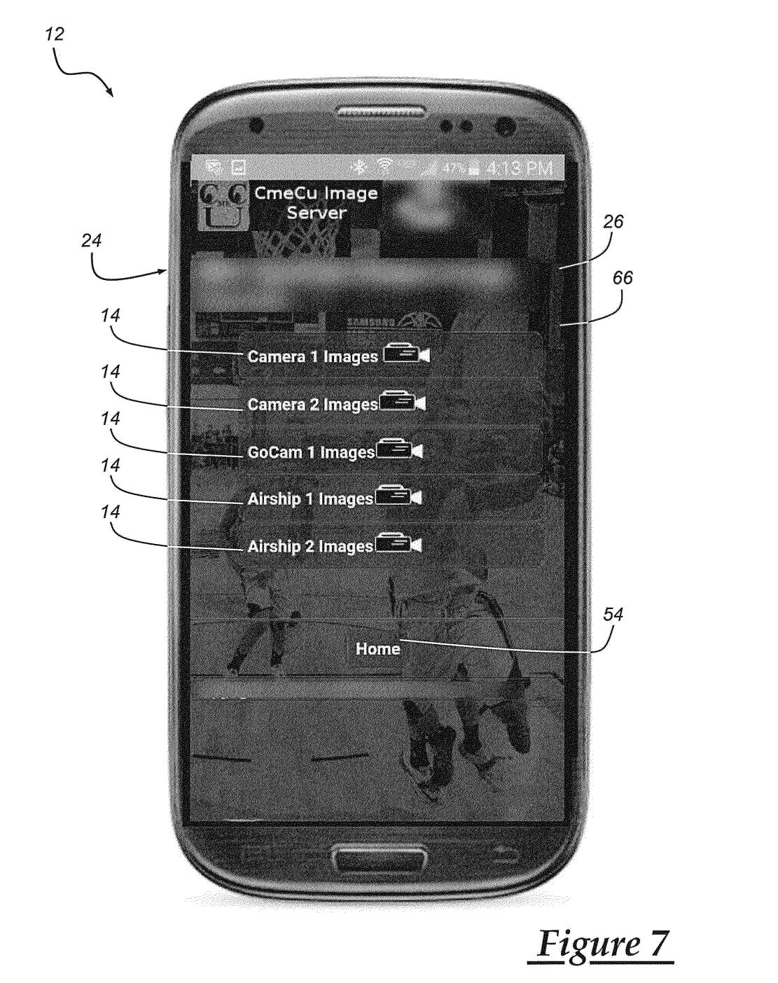

FIG. 3 is a screen shot of a representative first application program window 42 according to one embodiment. The first application program window 42 displays a plurality of selectable media items 28 received by the application program from a storage device such as remote storage device 16 over a communications network such as communications network 22. Upon user selection, at least one of the media items 28 can be added to a post that may be shared with at least one social media platform 20. Skilled artisans will appreciate that there are numerous ways and options for displaying media items 28, and that the organization of media items 28 as thumbnails such as those shown in FIG. 3 is merely exemplary. for example, the first application program window may display media items provided by the remote storage device in a browser-like manner or allow the user to scroll through media items individually. In another embodiment, each media item may be presented with a corresponding hyperlink to allow for user selection. The first application program window may further include instructions or other program information 44 that may be helpful for a user. For example, in this embodiment, the first application program window 42 includes a source list link, which may direct a user to one or more media item sources, such as that shown in FIG. 7 and described later in further detail. One or more social media platform login links may be also included. The first application program may display other controls or content not shown in FIG. 3 such as search features or aesthetic embellishments. Upon selection of a media item 28, a second application program window may be generated by the application program.

Second Application Program Window

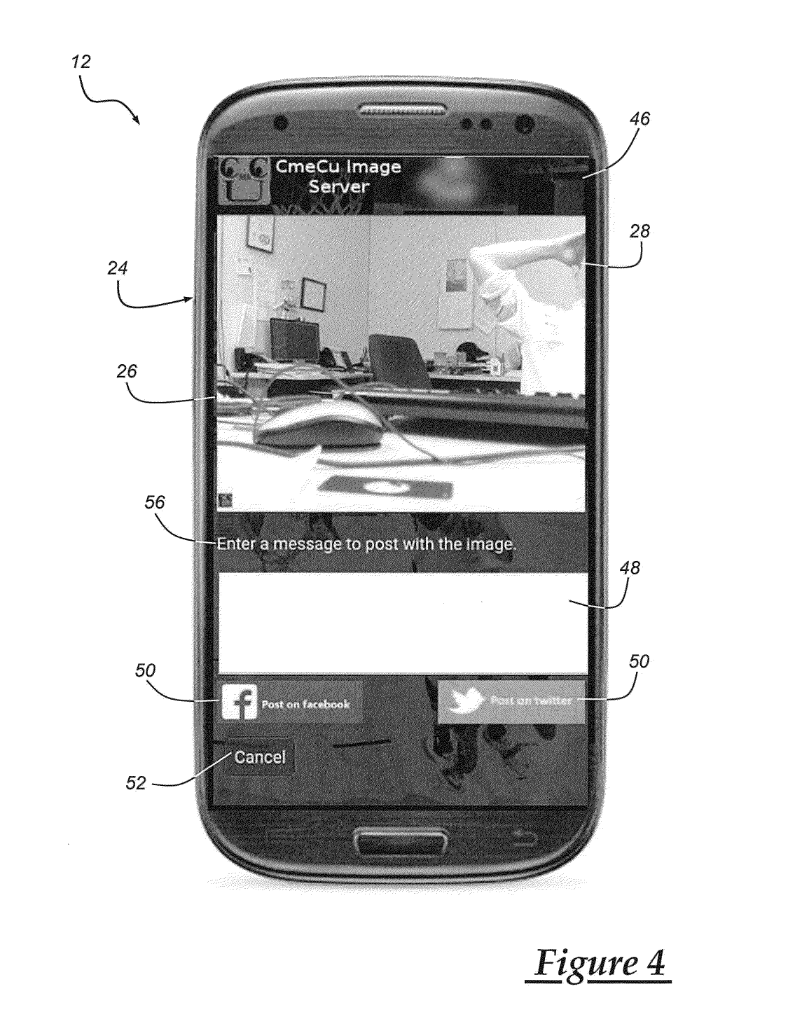

FIG. 4 is a screen shot of a representative second application program window 46 according to one embodiment. The second application program window 46 is presented on the electronic display 26 of the user's computing device 12. The second application program window 46 is generated by the application program upon selection of one or more media items. In accordance with the embodiment shown in FIG. 4, the media item 28 is presented to the user as an enlarged version.

The second application program window 46 displays the post containing at least one selected media item 28. As previously described, the post may include only the at least one selected media item, or in other embodiments, may also include user input material. FIG. 6 shows an exemplary post as displayed on Facebook which includes the media item 28 and user input material 64 in the form of text. With reference to FIG. 4, the second application program window 46 may include a user input space 48 which allows for the addition of user input material to the post. User input material may include, but is not limited to, text, emojis and other icons, audio excerpts, and other media items such as images and/or videos previously stored on the memory of the user's computing device.

Once a post is created, the user can employ one or more command links 50 that upon selection, send the post from the remote storage device to an intermediate server or a social media platform. If the post is sent to an intermediate server, it may then be retrieved by a social media platform or otherwise sent to the social media platform via a push notification, to cite one example. In the illustrated embodiment, the command link 50 is a post button, however other command link designs are certainly possible. For example, the command link may be in the form of a hyperlink associated with the enlarged media item 28 that is activated upon haptic input from the user. This particular embodiment includes two command links 50, one per social media platform, although this is not necessary. Additions to the second application program window 46 may include a cancel link 52 that deletes or otherwise cancels the post, a home link to exit or return the user to the first application program window or another application program or sub-program, and instructions 56 to assist the user in creating and sharing the post. Other additional functional or aesthetic features beyond those shown may also be included.

Third Application Program Window

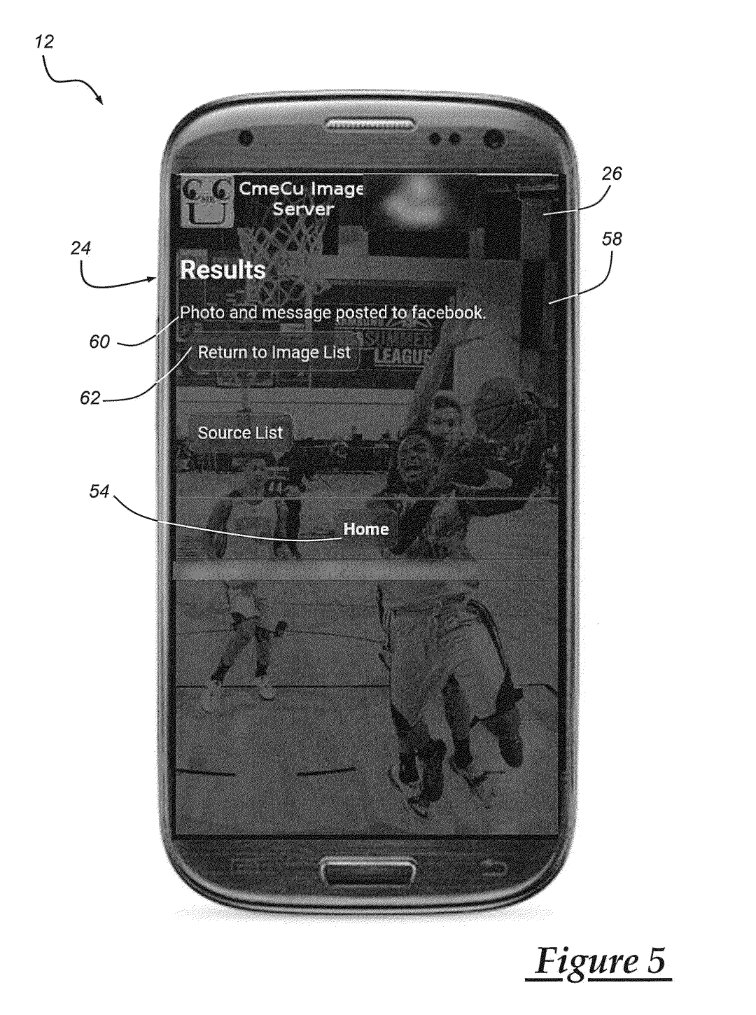

In accordance with one particular embodiment, upon selection of one of the command links 50 shown in FIG. 4, a third application program window 58, such as the screen shot represented in FIG. 5, may be generated. The generation of the third application program window may be contingent upon digital confirmation that the post was actually received by the social media platform. The third application program window 58 may display a confirmation 60 that the post has been posted to the social media platform. The third application program window 58 may also include a home link 54 as described above, and a return link 62 that upon selection, presents the first application program window 42, and/or a source list link. As mentioned with regard to the other application program windows, various other functional and aesthetic features may be incorporated, as will be apparent to one having ordinary skill in the art.

Optional Application Program Window

As shown in FIG. 7 optional application program window 66 may be generated by the application program. In one embodiment, the optional application program window 66 is presented before the first application program window 42. The optional application program window 66 lists various third party media sources 14, and the media items 28 that are displayed on the first application program window 42 may be sorted in accordance with the listed third party media sources. Accordingly, the third party media sources 14 may serve as a link to generate a first application program window 42 that displays media items obtained by the particularly chosen media source.

Methods

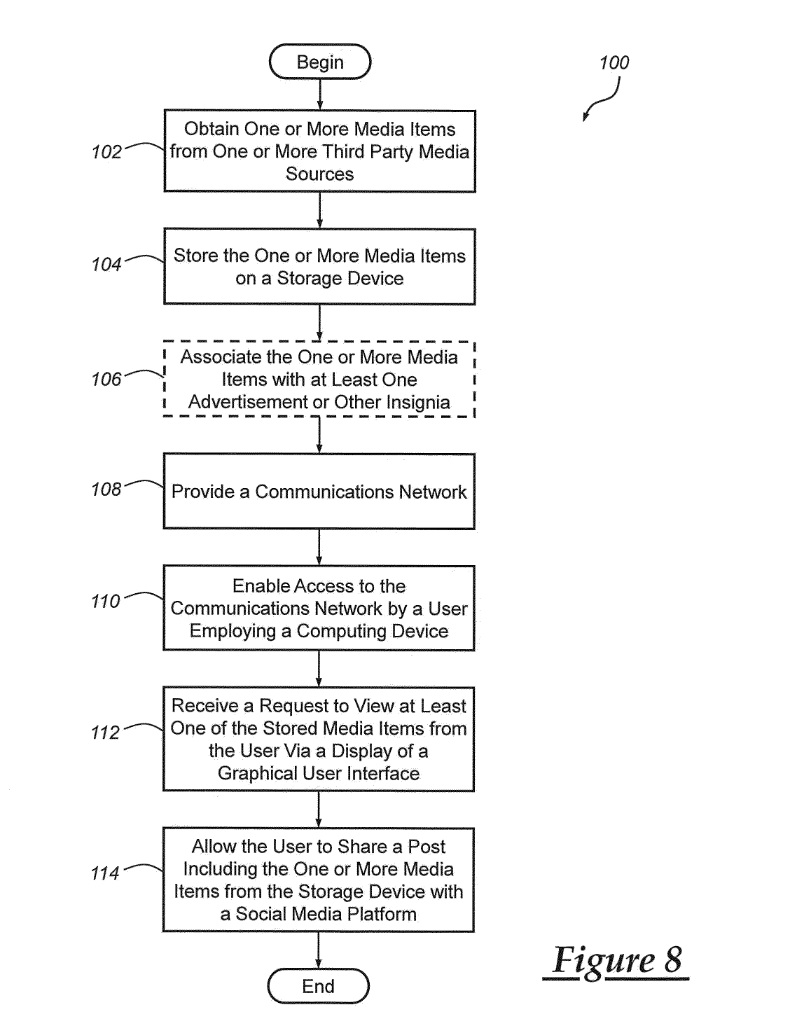

With reference to FIG. 8, there is shown an embodiment of a method 100 for sharing media items obtained from third party sources. The method is able to offload data transmission through the communications network by streamlining the data distribution process and allowing users to share media items without storing them on the memory of their personal computing devices. The method also facilitates user access to media items that may not have been otherwise available to them. The method steps may or may not be sequentially processed, and the present disclosure encompasses any sequencing, overlap, or parallel processing of such steps. The method 100 or portions thereof may be embodied in one or more computer programs or software in any computer-readable medium for use by or in connection with the system 10 shown in FIG. 1.

Beginning with step 102, the method obtains one or more media items from one or more third party media sources. As previously discussed, the media items may be in various sizes, qualities, and formats, including but not limited to Jpeg, Mpeg, PNG, GIF, MOV, etc. The media items may include any number and/or combination of still images, videos, and audio excerpts. The media items may be obtained directly from the third party sources via the Internet or some other wireless or communications network. Step 102 may include the optional substep of segmenting one media item into a plurality of media items, such as segmenting a video into numerous still images or video clips, for example. Such segmenting, processing, or analyzing may be accomplished through the use of high dynamic range imaging (HDRI or HDR), frequency band analysis, hyper spectral imaging, motion detection and/or recognition, and other techniques. It is also be possible to use various segmenting, processing, or analyzing techniques at other or multiple steps of the current method. Further, the media item may include additional information such as a camera identifier identifying the particular third party media source that obtained the image, a time stamp corresponding to when the media item was obtained, and/or position of the third party media source indicating the location of the third party media source that obtained the media item. Such information may be used, although is not necessary or necessarily used, to assist in cataloging and otherwise organizing the media items for presentation to a user. Moreover, the method is not limited in the frequency in which media items are obtained. For example, a video stream media item may be continuously streamed from a third party media source, or images may be obtained every few seconds from a third party media source such as camera 30. The preceding examples are meant to demonstrate some of the potential ways in which step 102 may obtain media items from third party media sources, and they are meant to emphasize that step 102 is not limited to any particular embodiment. Once the media items have been obtained, the method proceeds to step 104.

Step 104 involves storing the one or more media items on a storage device. In the example system 10 shown in FIG. 1, third party media sources 14 such as cameras 30 and video sources 32 provide media items that are uploaded to (or otherwise downloaded by) the storage device 16. In accordance with another embodiment, the third party media sources include an internal storage device that can facilitate data transmission to one or more other storage devices, servers, databases, or social media platforms, for example. It is possible to process media items once they are stored on the storage device. As previously eluded to, any suitable processing techniques may be used including, but not limited to, cataloging, grouping, thresholding, edge detecting, transforming, matching, filtering, segmentation, classification techniques, motion detection, object and feature detection, frequency waveform analysis, as well as any others known in the art.

Step 106, which is optional and not necessarily required, involves associating the one or more media items with at least one advertisement or other insignia. For example, banner-style advertisements may be added to still images or video clips. In accordance with another embodiment, if the third party media sources include a network broadcast of a sporting event for example, the team's logo or an indication of the network provider may be added to video clips or images of the event. Video clips may include an audio or video advertisement or message appended to the beginning, middle, or end of the clip. It should be appreciated that this step may occur at step 102 when the media items are obtained from the third party media sources; at step 104 when the media items are stored on a storage device, such as remote storage device 16 or intermediate storage device 18 depicted in FIG. 1; or later in the method. Moreover, numerous types, styles, and placements of advertisements and other insignia are certainly possible.

Step 108 involves providing a communications network. As previously described, the communications network may be provided in the form of any wireless network, HD wireless network, land network, point-to-point network, cellular communication network, distributed antenna system (DAS), or any combination thereof, to cite a few possibilities. The communications network may be provided by a venue, residence, business, or other establishment through the use of a telecommunications or cable company, for example. Moreover, separate communications networks may be provided to facilitate data transmission between the third party media sources and the storage device, the user's computing devices and the storage device, the storage device and the social media platform, respectively. So long as data transmission is feasible between various system components such as those shown in FIG. 1, step 108 may be satisfied.

In step 110, access to the communications network is enabled by a user employing a computing device. The user employing a computing device, such as computing device 12, can access the communications network in a number of ways. For example, the computing device may have wireless or Bluetooth capability that facilitates connection to a remote storage device such as a server. Step 110 may be a passive step, wherein access to the communications network by the user employing a computing device occurs automatically, without any input from the user. In another embodiment, access to the communications network may require affirmative steps by the user such as agreement with certain terms and conditions. Other enablement methods will be apparent to those having ordinary skill in the art.

Step 112 involves receiving a request to view at least one of the stored media items from the user via a display of a graphical user interface. The display of the graphical user interface may be provided to the user through a web-based or application-based program, for example, and may facilitate the user's request to view at least one media item. The request may be received at the storage device where the media items are stored directly, such as wirelessly through the communications network, or may be subject to routing through various other servers or switches, for example. In accordance with one embodiment, the request is generated when the user opens an application program stored in the memory of the user's computing device.

Step 114 allows the user to share a post including the one or more media items from the storage device with a social media platform. Besides the one or more media items, the post may further include user input material such as text. Step 114 may involve pushing the post to an intermediate server 18 such as a cloud so that it can be retrieved by a social media platform 20. In another embodiment, the social media platform may retrieve the post directly from the remote storage device 16. Moreover, other servers, databases, routers, etc. may assist or otherwise participate in the facilitation of the transmission of the post to the social media platform. Various data transmission architectures and configurations may be used to allow the user to share the post with the social media platform without storing the one or more media items on the memory of the user's computing device, thereby offloading network demands and reducing the number of user steps to post the media item.

The foregoing description is considered illustrative only. The terminology that is used is intended to be in the nature of words of description rather than of limitation. Many modifications and variations will readily occur to those skilled in the art in view of the description. For example, the specific combination and order of steps shown in the flowchart is just one possibility, as the present method may include a combination of steps that has fewer, greater, or different steps than that shown here. It is certainly possible for some of the illustrated steps (like steps, 102, 104, 106, etc) to be combined or otherwise integrated into others. Thus, the foregoing description is not intended to limit the invention to the embodiments described above. Accordingly the scope of the invention is defined by the appended claims.

What is claimed is:

1. A method for sharing media items from third party media sources, comprising the steps of:
obtaining one or more media items from one or more third party media sources;
storing the one or more media items on a storage device;
providing a communications network;
enabling access to the communications network by a user employing a computing device, the computing device having memory and a graphical user interface including an electronic display;
receiving a request to view at least one of the stored media items from the user via the graphical user interface display of the user's computing device, which allows the user to select among the media items; and
allowing the user to share a post including the one or more media items from the storage device with a social media platform without storing the one or more media items on the memory of the user's computing device.

2. The method of claim 1, wherein the obtaining step includes obtaining one media item from one third party media source.

3. The method of claim 2, further comprising the step of segmenting the one media item into a plurality of media items.

4. The method of claim 3, wherein the segmenting step is accomplished by a motion detection program.

5. The method of claim 1, further comprising the step of associating the one or more media items with an advertisement before the one or more media items can be shared by the user.

6. The method of claim 1, wherein the media item is an image.

7. The method of claim 1, wherein the media item is a video.

8. The method of claim 1, wherein the one or more media items are images and videos.

9. The method of claim 1, wherein the third party media source is a camera.

10. The method of claim 1, wherein the third party media source is a network broadcast.

11. The method of claim 1, wherein the storage device is a server.

12. The method of claim 11, further comprising the step of uploading the one or more media items from the one or more third party media sources to the server.

13. The method of claim 1, wherein the post further includes user input material.

14. The method of claim 13, wherein the user input material includes text.

15. A system configured to perform the method of claim 1.

16. A graphical user interface produced by an application program operating on a computing device having an electronic display, comprising:
a first application program window presented on the electronic display, the first application program window being generated by the application program operating on the computing device, wherein the first application program window displays a plurality of selectable media items received by the application program from a remote storage device over a communications network,
wherein, upon user selection, at least one media item can be added to a post that will be shared with at least one social media platform; and
a second application program window presented on the electronic display, the second application program window being generated by the application program operating on the computing device, wherein the second application program window displays the post containing the at least one selected media item and the post is received by the at least one social media platform from the remote storage device.

17. The graphical user interface of claim 16, wherein the second application program window displays an enlarged version of the at least one selected media item.

18. The graphical user interface of claim 16, wherein the second application program window includes a user input space for user input material that can be added to the post.

19. The graphical user interface of claim 16, wherein the second application program window includes a command link that upon selection, sends the post from the remote storage device to an intermediate storage device.

20. The graphical user interface of claim 19, wherein the post is retrieved from the intermediate storage device by the social media platform.

21. The graphical user interface of claim 20, wherein, upon selection of the command link, a third application program window is presented on the electronic display, the third application program window being generated by the application program operating on the computing device, wherein the third application program window displays a confirmation that the post has been posted to the social media platform.

22. The graphical user interface of claim 21, wherein the third application program window further displays a return link that upon selection, presents the first application program window.

23. The graphical user interface of claim 16, further including an optional application program window that includes links to the first application program window sorted by the third party media sources that obtained the media items.
